(19) United States
(12) Patent Application Publication
(10) Pub. No.: US 2010/0307160 A1
(43) Pub. Date: Dec. 9, 2010

(54) Convex Pilot Cone

(76) Inventors: Vinayak Barve, Orlando, FL (US); Michael Huth, Essen (DE); Kyle L. Landry, Winter Park, FL (US); Bernhard Wegner, Mulheim (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/429,318

(22) Filed: Jun. 3, 2009

(51) Int. Cl. F02C 7/22

(52) U.S. Cl. 60/748

(57) ABSTRACT

A gas turbine combustor is provided. The gas turbine combustor has a pilot nozzle having a pilot fuel injection port at a downstream end, in terms of the direction flow of a fuel, and lies on the axial centreline of the gas turbine combustor. It also has a main combustion zone, downstream of the pilot nozzle, and a pilot cone projecting from the vicinity of the pilot fuel injection port and having a diverged end adjacent to the main combustion zone, wherein a half angle of the pilot cone is increasing in the downstream direction.

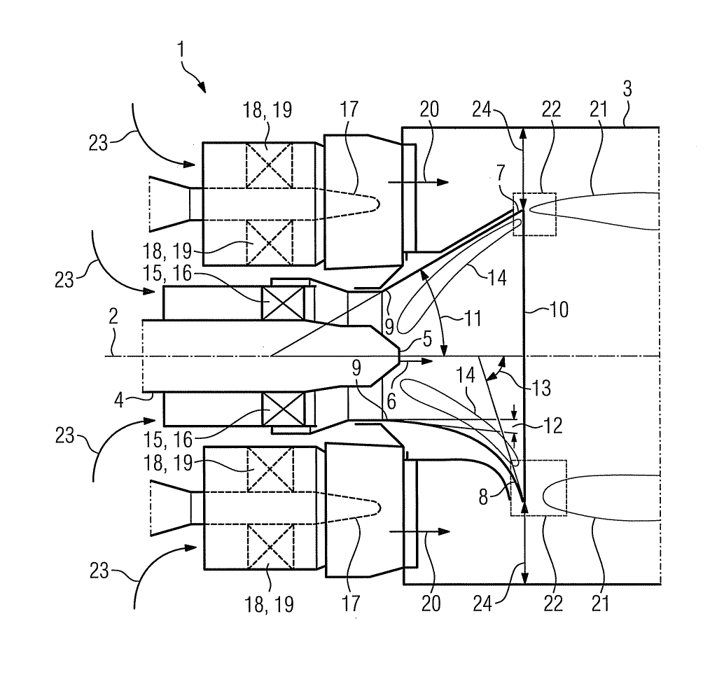

### FIELD OF THE INVENTION

The present invention relates to a gas turbine combustor and a gas turbine comprising the same.

### BACKGROUND OF THE INVENTION

Gas turbines are known to comprise the following elements: a compressor for compressing air; a combustor for producing a hot gas by burning fuel in the presence of the compressed air produced by the compressor; and a turbine for expanding the hot gas produced by the combustor. Gas turbines are known to emit undesirable oxides of nitrogen (NOx) and carbon monoxide (CO). One factor known to affect NOx emission is combustion temperature. The amount of NOx emitted is reduced as the combustion temperature is lowered. However, higher combustion temperatures are desirable to obtain higher efficiency and CO oxidation.

In actual can based combustion systems combustion is staged to cover the complete range of load conditions. Multi-stage combustion systems have been developed that provide efficient combustion and reduced NOx emissions. Thus, in a two-stage combustion system, diffusion combustion is performed at the first stage and is required for low-load operation and for stabilization of the main stage at high load/base load conditions. Premixed combustion is performed at the second stage to reduce NOx emussions.

The first stage, referred to hereinafter as the “pilot” stage, is normally a diffusion-type burner and is, therefore, a significant contributor of NOx emissions even though the percentage of fuel supplied to the pilot is comparatively quite small (often less than 10% of the total fuel supplied to the combustor). The pilot flame is one of the main tuning parameters to achieve required NOx emissions at acceptable acoustic amplitudes. To avoid acoustic instability the pilot stage has to be operated more fuel rich than the main stage, therefore contributing strongly to the overall NOx emissions of the combustion system. These acoustic instabilities are linked to a weak flame stabilization of the main stage.

In EP0594127 there is described a gas turbine combustor for reducing generation of NOx by mixing a fuel and air homogeneously and by improving the flame holdability of a pilot fame. At the centre of the gas turbine combustor, there is arranged a pilot nozzle which is surrounded by a plurality of main nozzles. From the vicinity of the injection port of the pilot nozzle there is projected a diverging cone which improves the flame holding of the main flame by the pilot flame, so that the generation of NOx by the pilot can be reduced.

The pilot flame is located within the pilot cone. The pilot flame itself is stabilized by a central recirculation zone. The hot gases of the pilot flame are then entrained and mixed into the fresh gas of the mains leading to their ignition and formation of the main flame downstream of the pilot cone trailing edge.

The pilot cone used in current engine designs typically consists of conical sheet metal parts mounted to a combustor base plate, where the cone has a half-angle of 30°.

The linear profile pilot cones known in the art are somewhat effective in controlling pilot flame stability by shielding the pilot flame from the influx of high velocity main gases. These pilot cones also form an annulus that prevents the main flame from moving upstream of the flame zone (flashback). However, constricted pilot recirculation zones and vortex shedding at the diverged ends of these pilot cones are known to cause instability in the pilot flame.

Similarly, it is known that leaner fuel/air mixtures burn cooler and thus decrease NOx emissions. One known technique for providing a leaner fuel mixture is to create turbulence to homogenize the air and fuel as much as possible before combustion. However, the pilot cones known in the art do little to create this type of turbulence.

As fuel mixtures become leaner, however, pilot flame stability becomes more important. That is, for a gas turbine combustor to be self-sustaining, the pilot flame must remain stable even in the presence of very lean fuel/air mixtures.

Thus, there is a need in the art for pilot cones that reduce NOx and CO emissions from gas turbine combustors by providing increased flame stability with leaner fuel/air mixtures.

### SUMMARY OF THE INVENTION

Embodiments of the invention satisfy these needs in the art by providing gas turbine combustors having pilot cones that reduce NOx and CO emissions by allowing the stable combustion of leaner fuel/air mixtures.

According to the invention there is provided a gas turbine combustor, comprising a pilot nozzle having a pilot fuel injection port at a downstream end in terms of the direction of flow of a fuel and being disposed on the axial centreline of said gas turbine combustor, a combustion zone downstream of said pilot nozzle, a pilot cone projecting from the vicinity of the pilot fuel injection port and having a diverged end adjacent to the main combustion zone, wherein a half angle of the pilot cone is increasing in downstream direction.

In other words, this improved pilot cone is not conical anymore, but is essentially a solid of revolution with a curvature similar to a trumpet, referred to hereinafter as “convex”.

The larger exit angle of the convex cone leads to a larger angle at which the hot pilot gas is mixed into the main stage fresh gas. This leads to a more intense mixing. Also, the blunt nature of the cone trailing edge might lead to the occurrence of local/instantaneous recirculation events similar to a wake flow leading to longer residence times for fluid parcels entering such zones. These facts lead to a stronger stabilization mechanism for the main flame.

High pressure tests conducted with the inventive design have already shown that this design is much less susceptible to the commonly found acoustic instability and the pilot fuel can be turned below values possible with the linear state of the art design.

CFD studies support these findings by indicating a stronger mixing and an increased heat release directly after the pilot cone trailing edge. The inventive design therefore promises an improved tuneability of the combustion system.

Advantageously the half angle is constantly increasing in downstream direction.

In an advantageous embodiment the half angle at a leading edge of the pilot cone is essentially zero.

In another advantageous embodiment, the half angle at a trailing edge of the pilot cone is less than or equal to 90°.

In a particularly advantageous embodiment the trailing edge half angle is 45°.

This contour, where the half angle starts from zero and increases gradually is chosen such that the angle at which the pilot gas penetrates into the main flow is increased. Flow separation along the inside of the cone is prevented by the expanding nature of the pilot swirl flow.

It is advantageous, when at least one main nozzle is arranged parallel to the pilot nozzle.

Further, it is advantageous, when the gas turbine combustor comprises at least one main fuel swirler parallel to said pilot nozzle and adjacent to the main combustion zone, said main fuel swirler surrounding said main nozzle.

It is advantageous, when each main fuel swirler comprises a plurality of swirler vanes.

According to the invention there is also provided a gas turbine comprising: a compressor for compressing air; and a gas turbine combustor as defined in either of the above paragraphs, for producing a hot gas by burning a fuel in said compressed air.

Further features, properties and advantages of the present invention will become clear from the following description of an embodiment in conjunction with the accompanying drawing.

### BRIEF DESCRIPTION OF THE DRAWINGS

FIGURE shows a cross-sectional view of a gas turbine combustor, wherein the top half shows a prior art system with a true conical pilot cone and the lower half shows the convex shaped design of the invention.

### DETAILED DESCRIPTION OF THE PREFERRED EMBODIMENT

The FIGURE shows a sketch of the new design of the gas turbine combustor 1 comparing it to the old, the combustor having an axial centreline 2.

The top half of the FIGURE shows a cross-sectional view of a gas turbine combustor 1 known in the art with a true conical pilot cone 7, i.e. the profile of the pilot cone 7 is linear and the pilot cone's half angle 11 is constant from the leading 9 (upstream end in the direction of flow of fuel and air) to the trailing edge 10 so that the pilot cone forms a frustum or truncated cone.

The lower half of the FIGURE shows the convex shaped new design of the pilot cone 8. At the leading edge 9 of the new pilot cone 8 the leading edge half angle 12 of the pilot cone 8 is essentially zero. The half angle is constantly increasing in downstream direction so that a trailing edge half angle 13 is less than or equal to 90°, preferably 45°. In a strict mathematical sense the new convex cone is not a cone any more since the lateral surface of a cone is formed by the locus of straight line segments. Therefore a more general definition could be a solid of revolution. Nevertheless the notion of cone shall be retained since that kind of component is generally known as “cone”.

The pilot flame 14 is located with the cone 7,8 feeding hot gases into a pilot-main interaction zone 22.

Premix fuel main nozzles 17 extend parallel to the pilot nozzle 4. The main flame 21 is ignited and anchored in the wake of the pilot cone 7,8. It is more compact and more strongly anchored in the case of the newly proposed convex cone 8.

A main combustion zone 21 is formed within liner 3 of the gas turbine combustor 1. The inventive pilot cone 8 projects from the vicinity of pilot fuel injection port 5 of the pilot nozzle 4 and has a diverged end 10 adjacent to the main combustion zone 21. The convex shaped pilot cone 8 has a convex profile forming a pilot flame zone 14.

Compressed air 23 from a compressor flows through main fuel swirlers 18 and passes by the main nozzles 17. The main fuel/air mixture 20 flows into the main combustion zone 21. Each main fuel swirler 18 has a plurality of swirler vanes 19.

Compressed air 23 also enters the pilot flame zone 14 through a set of stationary turning vanes 16 located inside pilot swirler 15. Compressed air 23 mixes with pilot fuel 6 within the convex pilot cone 8 and is carried into the pilot flame zone 14 where it combusts. The diverged downstream end 10 of convex pilot cone 8 forms an annulus 24 with liner 3.

Convex pilot cone 8 improves the mixture of air and fuel in the main combustion zone 21 by increasing the turbulence between the pilot flame zone 14 and main combustion zone 21.

1. A gas turbine combustor, comprising:
a pilot nozzle, having a pilot fuel injection port at a downstream end in terms of the direction of flow of a fuel and lies on the axial centreline of the gas turbine combustor;
a main combustion zone, located downstream of the pilot nozzle; and
a pilot cone, projecting from a vicinity of the pilot fuel injection port and having a diverged end adjacent to the main combustion zone,
wherein a half angle of the pilot cone is increasing in a downstream direction.

2. The gas turbine combustor as claimed in claim 1, wherein the half angle is constantly increasing in the downstream direction.

3. The gas turbine combustor as claimed in claim 2, wherein the half angle at a leading edge of the pilot cone is essentially zero.

4. The gas turbine combustor as claimed in claim 2, wherein a trailing edge half angle at the diverged end of the pilot cone is less than or equal to 90°.

5. The gas turbine combustor as claimed in claim 4, wherein the trailing edge half angle is 45°.

6. The gas turbine combustor as claimed in claim 1, wherein a main nozzle is arranged parallel to the pilot nozzle.

7. The gas turbine combustor as claimed in claim 1, further comprising:
a main fuel swirler, which lies parallel to the pilot nozzle and adjacent to the main combustion zone, and surrounds the main nozzle.

8. The gas turbine combustor as claimed in claim 7, wherein the main fuel swirler further comprises a plurality of swirler vanes.

9. The gas turbine combustor as claimed in claim 1, wherein the pilot cone is convex-shaped having a convex profile forming a pilot flame zone.

10. The gas turbine combustor as claimed in claim 9, wherein the convex pilot cone increases a turbulence between the pilot flame zone and the main combustion zone.

11. A gas turbine, comprising:
a compressor for compressing air; and
a gas turbine combustor, which produces a hot gas by burning a fuel in the compressed air, comprising:
a pilot nozzle, having a pilot fuel injection port at a downstream end in terms of the direction of flow of a fuel and lies on the axial centreline of the gas turbine combustor,
a main combustion zone, located downstream of the pilot nozzle, and
a pilot cone, projecting from a vicinity of the pilot fuel injection port and having a diverged end adjacent to the main combustion zone,
wherein a half angle of the pilot cone is increasing in a downstream direction.

12. The gas turbine as claimed in claim 9, wherein the half angle is constantly increasing in the downstream direction.

13. The gas turbine as claimed in claim 10, wherein the half angle at a leading edge of the pilot cone is essentially zero.

14. The gas turbine as claimed in claim 10, wherein a trailing edge half angle at the diverged end of the pilot cone is less than or equal to 90°.

15. The gas turbine as claimed in claim 12, wherein the trailing edge half angle is 45°.

16. The gas turbine as claimed in claim 9, wherein a main nozzle is arranged parallel to the pilot nozzle.

17. The gas turbine as claimed in claim 10, the gas turbine combustor further comprising:
a main fuel swirler, which lies parallel to the pilot nozzle and adjacent to the main combustion zone, and surrounds the main nozzle.

18. The gas turbine as claimed in claim 15, wherein the main fuel swirler further comprises a plurality of swirler vanes.

19. The gas turbine as claimed in claim 10, wherein the pilot cone is convex-shaped having a convex profile forming a pilot flame zone.

20. The gas turbine as claimed in claim 19, wherein the convex pilot cone increases a turbulence between the pilot flame zone and the main combustion zone.
